(19) United States
(12) Patent Application Publication
(10) Pub. No.: US 2025/0297710 A1
(43) Pub. Date: Sep. 25, 2025

(54) SYSTEM AND PROCESS FOR PRESSURE MANAGEMENT OF A LIQUID CARBON DIOXIDE RECEIVING FACILITY

(71) Applicant: Kraken Technology Holdings, LLC, Houston, TX (US)

(72) Inventors: Christopher Michael MILLER, Richmond, TX (US); Samantha Nicole BRYANT, Houston, TX (US); Byron Gladus BEST, III, Katy, TX (US); Bengt Arne JARLSJO, Houston, TX (US); Daniel Joseph SHAPIRO, Houston, TX (US)

(73) Assignee: Kraken Technology Holdings, LLC, Houston, TX (US)

(21) Appl. No.: 19/084,263

(22) Filed: Mar. 19, 2025

Related U.S. Application Data
(60) Provisional application No. 63/566,999, filed on Mar. 19, 2024.

(51) Int. Cl. F17C 13/04; F17C 7/04; F17C 13/02

(52) U.S. Cl. CPC F17C 13/04; F17C 7/04; F17C 13/025; F17C 2201/0104; F17C 2201/032; F17C 2201/035; F17C 2221/013; F17C 2225/0169; F17C 2250/043; F17C 2260/042; F17C 2265/034; F17C 2265/06; F17C 2270/01

(57) ABSTRACT

A method for controlling the operating pressure of a liquid carbon dioxide receiving facility is disclosed, the method comprising unloading liquid carbon dioxide from a transport vessel to the liquid carbon dioxide receiving facility, storing the liquid carbon dioxide in a temporary storage at the liquid carbon dioxide receiving facility, pumping the liquid carbon dioxide from the temporary storage to permanent geologic storage or external use, and managing pressure in the temporary storage using at least some of the carbon dioxide liquid phase.

### CROSS-REFERENCE TO RELATED APPLICATION

This application claims the benefit of U.S. Prov. App. Nos. 63/566,999 (filed Mar. 19, 2024), which is incorporated by reference herein in its entirety.

### BACKGROUND

The present invention relates to a system and a method for the pressure management of a liquid carbon dioxide receiving facility.

As the global economy prioritizes environmental, social, and governance (ESG) solutions, industrial and commercial facilities will focus on reducing and/or eliminating greenhouse gas emissions to meet climate initiative objectives. ESG targets will also drive industrial and commercial facilities to capture carbon dioxide, which can be for repurposed for beneficial use or permanently sequestered.

To support climate initiative goals, numerous industrial and commercial companies have committed to reducing their greenhouse gas emissions by using readily available carbon capture technologies and permanently storing the captured carbon dioxide (CO₂) in geological formations (sequestration). However, geological formations with adequate pore space for permanent carbon storage may not be located near the industrial and/or commercial facility. Industrial and commercial companies are actively adapting processes to capture and liquefy the carbon dioxide for long distance transportation via trucks, railcars, barges, and/or ocean-going ships to reach remote carbon sinks.

There are multiple viable solutions to capture and liquefy carbon dioxide for long distance transportation. Carbon dioxide capture technology, typically using either a cryogenic or a solvent-based solution, can be added to an industrial and/or commercial facility to reduce greenhouse gas emissions. A cryogenic capture solution produces a liquified carbon dioxide product whereas a solvent-based capture solution produces a carbon dioxide product that requires drying and liquefaction prior to long distance transportation. Liquid carbon dioxide (LCO₂) is shipped via transport vessels (e.g., trucks, railcars, barges, ocean-going ships) from the industrial and/or commercial facility and is unloaded at a receiving terminal (or liquid carbon dioxide receiving facility) for intermediate (or temporary) storage prior to external use or permanent geological storage.

The liquid carbon dioxide arrives at the receiving facility as a saturated or subcooled fluid and is unloaded from the transport vessel to temporary storage, which operates at or above the bubble point pressure of the transported liquid carbon dioxide to prevent flashing and minimize the required volume of the temporary storage. The operating pressure of the liquid carbon dioxide receiving facility must be controlled for the carbon dioxide to remain as a liquid in the temporary storage to prevent vapor generation.

Heat from the surrounding environment will cause the temperature of the liquid carbon dioxide in the temporary storage to increase until the fluid reaches the saturation temperature and starts to boil. As a result, the operating pressure of the receiving facility will increase until the boil-off gas is either vented to the atmosphere or removed from the temporary storage (i.e. condensed).

The present invention introduces a novel approach for the pressure management of a liquid carbon dioxide receiving facility that eliminates the need to vent carbon dioxide during normal operation of the receiving facility.

### SUMMARY OF THE INVENTION

The present invention relates to a system and method for controlling the operating pressure of a liquid carbon dioxide receiving facility, comprising the steps of unloading liquid carbon dioxide from a transport vessel to the liquid carbon dioxide receiving facility, storing the liquid carbon dioxide in a temporary storage at the liquid carbon dioxide receiving facility, wherein the temporary storage comprises a carbon dioxide liquid phase and a carbon dioxide vapor phase, wherein the addition of the liquid carbon dioxide increases the level of the liquid phase within the temporary storage, pumping the liquid carbon dioxide from the temporary storage to permanent geologic storage or external use, wherein the removal of liquid carbon dioxide decreases the level of the liquid phase within the temporary storage, and managing pressure in the temporary storage using at least some of the carbon dioxide liquid phase. The temporary storage is selected from one or more horizontal vessels, vertical vessels, spheres, or a combination thereof. The liquid carbon dioxide is transported to the receiving facility using transport vessels selected from one or more of trucks, railcars, barges, ocean-going ships, pipelines, or a combination thereof.

In one embodiment of the present invention, at least a portion of the liquid carbon dioxide is subcooled, wherein the pressure of the temporary storage is reduced during the storing step by the addition of the subcooled liquid carbon dioxide to the temporary storage. This is achieved by spraying at least some of the subcooled liquid carbon dioxide as liquid droplets directly in the temporary storage to condense a portion of the carbon dioxide vapor phase and reduce the pressure of the temporary storage. This is also achieved by adding at least some of the subcooled liquid carbon dioxide below the liquid level of the carbon dioxide liquid phase and condensing carbon dioxide vapor phase on the surface of the vapor-liquid interface thereby indirectly reducing the pressure of the temporary storage. The subcooled liquid carbon dioxide is provided by unloading a transport vessel containing carbon dioxide as either a subcooled or saturated liquid that can be pumped to a pressure that exceeds the bubble point of transported fluid at the pressure of the temporary storage.

In another embodiment of the present invention, the managing pressure step further comprises vaporizing at least some of the carbon dioxide liquid phase at a rate sufficient to offset the pressure reduction caused by the pumping step. The carbon dioxide liquid phase is vaporized at a volumetric rate equal to the pumping rate of liquid carbon dioxide from the temporary storage minus the rate of boil-off gas generation rate due to heat ingress.

In yet another embodiment of the present invention, the managing pressure step further comprises vaporizing at least some of the carbon dioxide liquid phase at a rate sufficient to increase the pressure of the temporary storage. The carbon dioxide liquid phase is vaporized at a volumetric rate greater than the pumping rate of liquid carbon dioxide from the temporary storage minus the rate of boil-off gas generation rate due to heat ingress.

In yet another embodiment of the present invention, the pressure control for the temporary storage regulates the amount of subcooled liquid carbon dioxide added to the temporary storage. The pressure control for the temporary storage increases or decreases the heat input to vaporize the liquid carbon dioxide.

### DESCRIPTION OF FIGURES

The features and advantages of the present invention will be more clearly understood from the following description taken in conjunction with the accompanying drawings in which:

FIG. 1 depicts a process flow diagram for a liquefied carbon dioxide receiving facility in which some of the liquid carbon dioxide is used to control the operating pressure of the temporary storage.

FIG. 2 depicts the storage vessel (or storage bullet) internal hardware and associated instrumentation that distributes the liquid carbon dioxide within the storage vessel to control the operating pressure of the temporary storage.

### DETAILED DESCRIPTION OF THE INVENTION

This present invention relates to a system and a method for the pressure management of a liquid carbon dioxide receiving facility.

In all embodiments described herein, carbon dioxide is captured and liquefied at an industrial source and then is transported to the liquid carbon dioxide receiving facility for intermediate (or temporary) storage prior to external use or permanent geologic storage (sequestration).

In all embodiments described herein, the terms “receiving facility”, “LCO₂ receiving facility”, “receiving terminal”, and “LCO₂ receiving terminal” are used interchangeably and describe any inland, waterfront, or offshore facility used for the purposes of receiving, storing, processing, handling, and transportation of liquid carbon dioxide.

In all embodiments described herein, the terms “vessel”, “storage vessel”, “bullet”, “storage bullet”, “tank”, and “storage tank” are used interchangeably when referring to the physical equipment used for temporary storage of the liquid carbon dioxide at the receiving facility.

In all embodiments described herein, the liquid carbon dioxide is transported to the receiving facility via one or more liquid carbon dioxide transport vessels that includes, but is not limited to, trucks, railcars, barges and/or ocean-going ships.

In all embodiments described herein, the liquid carbon dioxide transport vessels operate at low, medium, and/or elevated pressure at saturation and/or subcooled temperatures. Typically, low pressure LCO₂ transport vessels operate between about 6 to 10 barg at about −45 to −50° C., medium pressure LCO₂ transport vessels operate between about 15 to 18 barg at about −25 to −30° C., and elevated pressure LCO₂ transport vessels operate between about 34 to 45 barg at about 0 to 10° C.

In all embodiments described herein, “unloading operation” describes the process when a liquid carbon dioxide transport vessel is unloaded to temporary storage while the liquid carbon dioxide from temporary storage is simultaneously directed to external use or permanent geologic storage.

In all embodiments described herein, “normal operation” describes the steady-state process when the liquid carbon dioxide from temporary storage is directed to external use or permanent geologic storage (i.e., a transport vessel is not being simultaneously unloaded).

Furthermore, in all embodiments described herein, temporary storage may be selected from one or more horizontal vessels, vertical vessels, spheres, or a combination thereof.

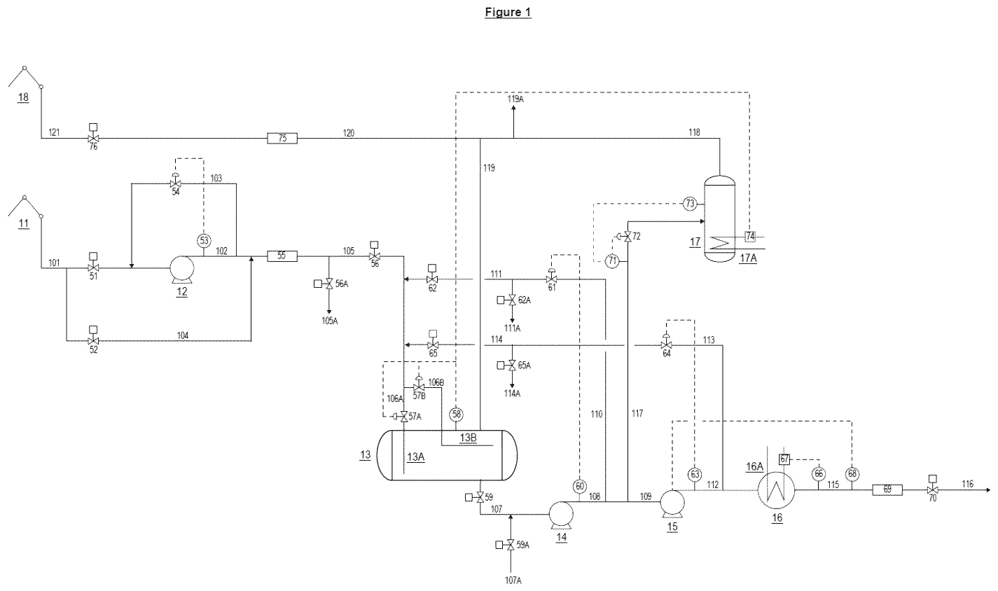

With reference to FIG. 1, a first illustrative embodiment of the present invention is depicted in which some of the liquid carbon dioxide is used to control the operating pressure of the temporary storage during steady-state and unloading operations.

Liquid carbon dioxide is transported to the receiving facility via transport vessels that arrive at either low, medium, or elevated pressure. The transport vessel is connected to Unloading 11 where liquid carbon dioxide 101 is unloaded to the LCO₂ receiving facility. Depending on the equipment associated with the transport vessel, the liquid carbon dioxide can be either pumped or pressurized from the transport vessel to Unloading 11.

Although depicted as a single, liquid unloading arm in FIG. 1, Unloading 11 may be comprised of one or more unloading arms or one or more flexible hoses that connect to a common unloading manifold at the receiving facility. The unloading arm(s) or hose(s) connect to the transport vessel and are designed to account for any movement of the transport vessel during unloading (i.e. movement due to waves or tides for marine transport vessels).

Liquid carbon dioxide must be at or above the bubble point (or saturation) pressure of the transported fluid to prevent flashing (or vapor generation) and remain as a liquid. Depending on the pressure in which the liquid carbon dioxide is unloaded from the transport vessel, pressure losses in the unloading system between Unloading 11 and Storage Vessel 13 may lead to the liquid carbon dioxide flashing upstream of Storage Vessel 13. Liquid carbon dioxide 101 may need to be pumped to overcome the frictional and mechanical pressure losses and any static head between Unloading 11 and Storage Vessel 13.

From Unloading 11, liquid carbon dioxide 101 enters the unloading manifold where Valves 51 and 52 direct the flow of the fluid. When liquid carbon dioxide 101 requires additional pressure to overcome frictional and mechanical pressure losses and/or static head in the unloading system, Valve 51 is opened, Valve 52 is closed, and liquid carbon dioxide 101 is directed to Unloading Pump 12. When the pressure of liquid carbon dioxide 101 is sufficient for the fluid to arrive at Storage Vessel 13 without flashing, Valve 51 is closed, Valves 52 is open, and liquid carbon dioxide 104 bypasses Unloading Pump 12. During normal operation, Valves 51 and 52 are closed.

Unloading Pump 12 increases the pressure of liquid carbon dioxide 101 to overcome the pressure losses in the unloading system. Unloading pump discharge 102 is routed to Meter 55 to measure the liquid carbon dioxide flow for custody (or fiscal) transfer between multiple parties.

Meter 55 could be located between the common unloading manifold in Unloading 11 and Unloading Pump 12 provided that the pressure of liquid carbon dioxide 101 is sufficient to prevent flashing across the flow meter and eliminate the presence of vapor in the suction of Unloading Pump 12 which could lead to cavitation. As illustrated in FIG. 1, Meter 55 is located downstream of Unloading Pump 12 to reduce the pressure losses between Unloading 11 and the suction of Unloading Pump 12, thereby allowing the transport vessels to be unloaded at or slightly above the bubble point of the transported fluid.

Unloading Pump 12 is depicted as a centrifugal pump in FIG. 1, with a minimum flow control loop to provide stable operation across a wide range of unloading flow rates from different transport vessels. Flow Meter 53 measures the flow rate of unloading pump discharge 102. As the flow rate of unloading pump discharge 102 decreases, Flow Meter 53 signals Minimum Flow Control Valve 54 to open, recycling unloading pump minimum flow 103 back to the suction of Unloading Pump 12, maintaining the flow rate at or above the pump's minimum continuous stable flow. When the flow rate of unloading pump discharge 102 exceeds the pump's minimum continuous stable flow, Flow Meter 53 signals Minimum Flow Control Valve 54 to close, stopping the recycling of unloading pump minimum flow 103.

The unloading system (i.e., facilities upstream of Meter 55) may be situated near the transport vessels' arrival location rather than at the temporary storage site.

From Meter 55, liquid carbon dioxide feed 105 is routed to temporary (or intermediate) storage. Depending on the storage volume requirements and/or physical constraints of the liquid carbon dioxide receiving facility, temporary storage may consist of more than one Storage Vessel 13 as illustrated in FIG. 1 (second storage vessel is omitted for clarity).

Valves 56 and 56A direct the flow of liquid carbon dioxide feed 105 to the storage vessel with available capacity. When a liquid carbon dioxide transport vessel is unloaded for temporary storage in Storage Vessel 13, Valve 56 is opened, Valve 56A is closed, and liquid carbon dioxide feed 105 is directed to Storage Vessel 13. As the unloading operation continues and Storage Vessel 13 becomes full, Valve 56 is closed, Valve 56A is opened, and diverted liquid carbon dioxide feed 105A is routed to the second storage vessel (not shown in FIG. 1). After the unloading operation has finished, both Valves 56 and 56A are closed to ensure that the upstream system remains liquid full.

When two or more storage vessels have available capacity to receive the contents of a liquid carbon dioxide transport vessel, Valves 56 and 56A are opened, and liquid carbon dioxide feed 105 is directed to the storage vessels. As the unloading operation continues and Storage Vessel 13 becomes full, Valve 56 is closed and diverted liquid carbon dioxide feed 105A continues to the second storage vessel (not shown in FIG. 1). Valve 56A is closed when the second storage vessel becomes liquid full or when the unloading operation has finished.

Liquid carbon dioxide feed 105 enters the feed manifold where Control Valves 57A and 57B direct the flow of liquid carbon dioxide inlet 106A and 106B to Inlet Distributor 13A and 13B. Pressure Controller 58 measures the operating pressure of Storage Vessel 13 and signals Control Valves 57A and 57B to throttle during an unloading operation to manipulate the operating pressure of Storage Vessel 13.

Liquid carbon dioxide inlet 106A and 106B arrive at Storage Vessel 13 as a subcooled liquid, with an operating pressure higher than that of the transport vessel in which it arrived. Liquid carbon dioxide inlet 106A is routed to Inlet Distributor 13A, a dip tube distributor that extends below the operating liquid level of Storage Vessel 13. Liquid carbon dioxide inlet 106B is routed to Inlet Distributor 13B, a liquid distributor that resides in the vapor space of Storage Vessel 13.

Storage Vessel 13 provides temporary storage, or buffer, for the receiving facility to accommodate the batch unloading of the transport vessels based on the timing of vessel arrivals at the receiving facility. The temporary storage allows for transport vessels to be unloaded at a rate greater than or equal to the capacity of the downstream receiving facility equipment and/or sequestration facilities.

Although carbon dioxide arrives at Storage Vessel 13 as a subcooled liquid, vapor generation occurs during normal operations. Storage Vessel 13 operates with both liquid and vapor phases and the volume of each varies depending on the operation of the receiving facility.

Vapor in Storage Vessel 13 is generated from heat ingress from the surrounding environment causing the liquid carbon dioxide to boil, producing boil-off gas (BOG), and from Vaporizer 17. When vapor generated in Storage Vessel 13 accumulates at a volumetric rate greater than the liquid leaving the storage vessel, the operating pressure of Storage Vessel 13 increases.

The operating pressure of Storage Vessel 13 can be reduced through the direct contact of subcooled liquid carbon dioxide with the vapor carbon dioxide in the storage vessel during unloading operations. Subcooled liquid enters Storage Vessel 13 below the operating liquid through Inlet Distributor 13A and condenses vapor carbon dioxide on the surface of the vapor-liquid interface. Subcooled liquid also enters Storage Vessel 13 through Inlet Distributor 13B and is sprayed into the vapor space of Storage Vessel 13. The subcooled liquid droplets contact and condense the carbon dioxide in the vapor space of the vessel. The reduction in operating pressure of Storage Vessel 13 is directly proportional to the total amount of subcooled liquid entering the vessel and the portion that is sent to Inlet Distributor 13A relative to Inlet Distributor 13B. The operating pressure of Storage Vessel 13 will decrease more rapidly by spraying liquid carbon dioxide through Inlet Distributor 13B into the vapor space of the vessel as compared to condensing the vapor carbon dioxide on the surface of the vapor-liquid interface through Inlet Distributor 13A. Pressure Controller 58 adjusts Control Valves 57A and 57B to regulate the amount of subcooled liquid sent to Inlet Distributor 13A relative to Inlet Distributor 13B based on the operating pressure of Storage Vessel 13.

During the unloading operation, the liquid level in Storage Vessel 13 increases, which reduces (or compresses) the vapor space and increases the operating pressure of Storage Vessel 13. The subcooled liquid introduced during the unloading operation condenses the carbon dioxide in the vapor space which maintains or reduces the operating pressure of Storage Vessel 13, as described above.

During normal operation, the liquid level in Storage Vessel 13 decreases as the liquid exits the storage vessel, which increases the vapor space and reduces the operating pressure of Storage Vessel 13. Carbon dioxide vapor can be generated in Vaporizer 17 and added to the vapor space to maintain or increase the operating pressure of Storage Vessel 13. To maintain the operating pressure as the liquid level decreases, carbon dioxide vapor will need to be added to Storage Vessel 13 at a volumetric rate equal to the rate of liquid leaving the vessel minus the boil-off gas generation rate.

Pressure Controller 58 signals Heater Control 74 to increase the duty of Vaporizer Element 17A to generate carbon dioxide vapor based on the operating pressure of Storage Vessel 13. Vaporizer 17 and Vaporizer Element 17A are described in depth in the following sections.

Valves 59 and 59A, located on the pump suction manifold, select which storage vessel(s) are emptied. When two or more storage vessels are simultaneously being emptied, both Valves 59 and 59A are opened, and booster pump suction 107 and 107A are directed to Booster Pump 14. As the liquid level in Storage Vessel 13 reaches the low liquid level, Valve 59 is closed and booster pump suction 107A continues to the second storage vessel. When both storage vessels reach the low liquid level, Booster Pump 14 and Product Pump 15 will recycle back to the second storage vessel (not shown in FIG. 1) and Valve 59A will remain open to avoid cavitation and damage to the pumps.

Booster Pump 14 increases the pressure of booster pump suction 107 and 107A to an intermediate operating pressure. A portion of booster pump discharge 108 is routed to Vaporizer 17 and the remaining liquid carbon dioxide is sent to Product Pump 15. The intermediate operating pressure of booster pump discharge 108 is determined by the net positive suction head required for Product Pump 15, as well as the pressure losses and static head between Booster Pump 14 and Vaporizer 17.

Booster Pump 14 is depicted as a centrifugal pump in FIG. 1, with a minimum flow control loop to provide stable operation across a wide range of flow rates. Flow Meter 60 measures the flow rate of booster pump discharge 108. As the flow rate of booster pump discharge 108 decreases, Flow Meter 60 signals Minimum Flow Control Valve 61 to open, recycling booster pump minimum flow 110 back to Storage Vessel 13, maintaining the flow rate at or above the pump's minimum continuous stable flow. When the flow rate of booster pump discharge 108 exceeds the pump's minimum continuous stable flow, Flow Meter 60 signals Minimum Flow Control Valve 61 to close, stopping the recycling of booster pump minimum flow 110.

Valves 62 and 62A on the pump discharge manifold determine which storage vessel(s) receive the recycled booster pump minimum flow 110. The position of Valves 62 and 62A should be the same as Valves 59 and 59A, respectively. Valves 62 and 62A direct booster pump minimum flow 111 and 111A to Storage Vessel 13 and/or the second storage vessel (not shown in FIG. 1).

The minimum flow control loop of Booster Pump 14 can also be used to provide subcooled liquid to Storage Vessel 13 to control the pressure and reduce vapor accumulation in the vessel during normal operation. Booster pump minimum flow 110 is a subcooled liquid at the intermediate operating pressure and can be recycled by Booster Pump 14 to Storage Vessel 13 through Inlet Distributor 13A and 13B. Although not shown in FIG. 1, Pressure Controller 58 signals Minimum Flow Control Valve 61 to open during normal operations to manipulate the operating pressure of Storage Vessel 13. Pressure Controller 58 should not override Flow Meter 60 to close Minimum Flow Control Valve 61, as this could lead to cavitation of Booster Pump 14.

Product Pump 15 increases the pressure of product pump suction 109 to the final disposition or pipeline operating pressure and is sent to Product Heater 16. Product Pump 15 may increase the operating pressure above the critical pressure of carbon dioxide (73.8 barg) such that the fluid is dense phase.

In FIG. 1, Product Pump 15 is depicted with a variable frequency drive to be able to control the pump discharge pressure or the receiving facility battery limit pressure across a wide range of flow rates. Pressure Controller 68 measures the operating pressure of heated carbon dioxide 115 and increases or decreases the speed of the pump motor to reach the specified operating pressure.

Product Pump 15 is depicted as a centrifugal pump in FIG. 1, with a minimum flow control loop to provide stable operation across a wide range of flow rates. Flow Meter 63 measures the flow rate of product pump discharge 112. As the flow rate of product pump discharge 112 decreases, Flow Meter 63 signals Minimum Flow Control Valve 64 to open, recycling product pump minimum flow 113 back to Storage Vessel 13, maintaining the flow rate at or above the pump's minimum continuous stable flow. When the flow rate of product pump discharge 112 exceeds the pump's minimum continuous stable flow, Flow Meter 63 signals Minimum Flow Control Valve 64 to close, stopping the recycling of booster pump minimum flow 113.

Valves 65 and 65A on the pump discharge manifold determine which storage vessel(s) receive the recycled product pump minimum flow 113. The position of Valves 65 and 65A should be the same as Valves 59 and 59A, respectively. Valves 65 and 65A direct product pump minimum flow 114 and 114A to Storage Vessel 13 and/or the second storage vessel (not shown in FIG. 1).

The minimum flow control loop of Product Pump 15 can also be used to provide subcooled liquid to Storage Vessel 13 to control the pressure and reduce vapor accumulation in the vessel during normal operation. Product pump minimum flow 113 is a subcooled liquid or dense phase fluid and can be recycled by Product Pump 15 to Storage Vessel 13 through Inlet Distributor 13A and 13B. Although not shown in FIG. 1, Pressure Controller 58 signals Minimum Flow Control Valve 64 to open during normal operations to manipulate the operating pressure of Storage Vessel 13. Pressure Controller 58 should not override Flow Meter 63 to close Minimum Flow Control Valve 64, as this could lead to cavitation of Product Pump 15.

Depending on the operating pressure of Storage Vessel 13 and the final disposition or pipeline operation pressure of the carbon dioxide, Product Pump 15 may not be required and could be removed from the receiving facility. In this configuration, booster pump discharge 108, is routed to Product Heater 16 and Vaporizer 17.

Liquid or dense phase carbon dioxide from Product Pump 15 is sent to Product Heater 16 where product pump discharge 112 is heated to the final disposition or pipeline operating temperature. Product Heater 16 may increase the operating temperature of the fluid above the critical temperature of the carbon dioxide (31.1° C.) such that the fluid is supercritical. Temperature Controller 66 signals Heater Control 67 to increase or decrease the duty of Heater Element 16A to reach the specified operating temperature.

Product Heater 15 is depicted with an electric heating element in FIG. 1. The heating duty for Product Heater 15 may be achieved using steam, condensate, tepid water, waste heat, and/or districting heating as would be well understood by one skilled in the art.

Heated carbon dioxide 115 is routed to Meter 69 to measure the liquid carbon dioxide flow for custody (or fiscal) transfer between multiple parties and leaves the receiving facility through Valve 70, which is only closed during an outage, as exported carbon dioxide 116.

Vaporizer 17 also controls the operating pressure of Storage Vessel 13. A slip stream from the discharge of Booster Pump 15 is routed to Vaporizer 17. Flow Controller 71 measures the flow rate of vaporizer feed 117 and signals Control Valve 72 to open or close accordingly. Level Controller 73 measures the liquid level in Vaporizer 17 and resets or adjusts the setpoint of Flow Controller 71 to maintain the liquid level in Vaporizer 17.

Vaporizer feed 117 enters Vaporizer 17 and is heated by Vaporizer Element 17A to generate vapor carbon dioxide 118. During normal operation, vapor carbon dioxide 118 is used to maintain or increase the operating pressure of Storage Vessel 13.

When the operating pressure of Storage Vessel 13 decreases, Pressure Controller 58 signals Heater Control 74 to increase the duty of Vaporizer Element 17A to generate additional carbon dioxide vapor that is sent to Storage Vessel 13 to increase the operating pressure. As more carbon dioxide vapor is being generated, the liquid level in Vaporizer 17 decreases, Level Controller 73 increases the setpoint of Flow Controller 71, and opens Control Valve 72 allowing more liquid carbon dioxide to enter Vaporizer 17 to maintain the liquid level.

When the operating pressure of Storage Vessel 13 increases, Pressure Controller 58 signals Heater Control 74 to decrease the duty of Vaporizer Element 17A to reduce the amount of carbon dioxide vapor that is generated. As the carbon dioxide vapor generation rate decreases, the liquid level in Vaporizer 17 increases, Level Controller 73 decreases the setpoint of Flow Controller 71 and closes Control Valve 72 to maintain the liquid level.

Vaporizer 17 is depicted with an electric heating element in FIG. 1. The heating duty for Vaporizer 17 may be achieved using steam, condensate, tepid water, waste heat, and/or districting heating as would be well understood by one skilled in the art.

Although not depicted in FIG. 1, Vaporizer Element 17A could be located inside Storage Vessel 13. In this configuration, Booster Pump 15, Vaporizer 17, and their associated controls may not be required and could be removed from the receiving facility.

Vapor carbon dioxide 118 from Vaporizer 17 is sent to the vapor header. From the vapor header, bi-directional vapor balance 119 and 119A equalize the operating pressure between Storage Vessel 13 and the second storage vessel (not shown in FIG. 1). Vapor balance 120 provides vapor carbon dioxide to the transport vessel during the unloading operation.

During the unloading operation, the liquid level of the transport vessel's compartments (or containers) decreases as the liquid carbon dioxide is transferred to the receiving facility, reducing the operating pressure. To maintain the operating pressure of the transport vessel, carbon dioxide vapor will need to be added at a volumetric rate equal to the rate of liquid leaving the compartment. Vapor balance 120 can provide vapor to the transport vessel from vapor displaced by the increase in liquid volume in Storage Vessel 13 during unloading or can also be generated by Vaporizer 17. Vapor balance 120 is routed to Meter 75 to measure the vapor carbon dioxide flow for custody transfer between multiple parties. Exported vapor carbon dioxide 121 passes through Valve 76 to Loading 18. Valve 76 is open during the unloading operation and closed during normal operations.

Loading 18 is connected to the transport vessel where export vapor carbon dioxide 121 is used to maintain the operating pressure of the transport vessel. Although depicted as a single, vapor loading arm in FIG. 1, Loading 18 may be comprised of one or more loading arms or one or more flexible hoses that connect to a common loading manifold at the receiving facility. The loading arm(s) or hose(s) connect to the transport vessel and are designed to account for any movement of the transport vessel during loading.

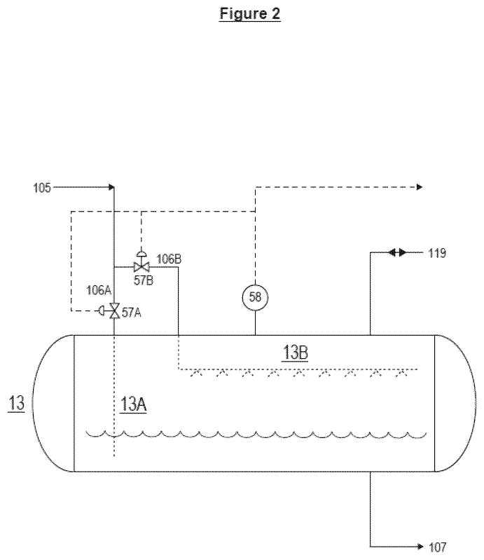

In a second illustrative embodiment of the present invention, FIG. 2 depicts Storage Vessel 13 and Inlet Distributor 13A and 13B.

Inlet Distributor 13A is a dip tube distributor that extends below the operating liquid level of Storage Vessel 13. The dip tube distributor directs the flow of the subcooled liquid carbon dioxide entering the vessel to the bottom of Storage Vessel 13, ensuring thorough and efficient distribution of the liquid. The dip tube may have a diameter less than, greater than, or equal to the diameter of the inlet pipe.

Inlet Distributor 13B is a liquid distributor that resides in the vapor space of Storage Vessel 13. The liquid distributor directs or sprays the subcooled liquid carbon dioxide into the vapor space of Storage Vessel 13, ensuring even distribution of the liquid. The liquid distributor may have a diameter less than, greater than, or equal to the diameter of the inlet pipe and may consist of multiple branches. The liquid distributor may include full cone, spiral full cone, hollow cone, flat fan, even flat-flan, or a combination thereof.

In a preferred aspect of the present invention, the liquid carbon dioxide in the temporary storage is subcooled. Furthermore, the temporary storage has both liquid and vapor phases and the volume of each varies depending on the operating mode of the receiving facility (e.g., unloading of transport vessel or steady-state export). The operating pressure of the temporary storage may be reduced by the direct contact of subcooled liquid carbon dioxide with vapor carbon dioxide in the temporary storage during unloading of liquid carbon dioxide. The operating pressure of the temporary storage may also be maintained by vaporizing at least some of the liquid carbon dioxide in the temporary storage to generate a vapor with a volumetric rate equal to the export rate of liquid carbon dioxide minus the boil-off gas generation rate. The operating pressure of the temporary storage may also be increased by vaporizing at least some of the liquid carbon dioxide in the temporary storage to generate a vapor with a volumetric rate greater than the export rate of liquid carbon dioxide minus the boil-off gas generation rate.

In yet another embodiment of the present invention, the method further comprises the step of spraying at least some of the subcooled liquid carbon dioxide as liquid droplets directly in the vapor phase of the temporary storage to condense the vapor carbon dioxide and reduce the operating pressure of the temporary storage. At least some of the subcooled liquid carbon dioxide enters the temporary storage below the liquid operating level and condenses vapor carbon dioxide on the surface of the vapor-liquid interface and indirectly reduces the operating pressure of the temporary storage, wherein the pressure control for the temporary storage regulates the amount of subcooled liquid carbon dioxide to both the vapor and liquid phases of the temporary storage. The subcooled liquid carbon dioxide may also be provided by unloading a transport vessel containing carbon dioxide as either a subcooled or saturated liquid that can be pumped to a pressure that exceeds the bubble point of transported fluid at the operating pressure of the temporary storage. The subcooled liquid carbon dioxide may also be provided by recirculating the subcooled liquid carbon dioxide back to temporary storage.

In yet another embodiment of the present invention, the pressure control for the temporary storage increases or decreases the heat input to vaporize the liquid carbon dioxide. The pressure control for the temporary storage may also be a split range pressure controller. The temporary storage may be selected from one or more horizontal vessels, vertical vessels, spheres, or a combination thereof. Liquid carbon dioxide may be transported to the receiving facility using transport vessels selected from one or more of trucks, railcars, barges, ocean-going ships, pipelines, or a combination thereof.

In yet another embodiment, the present invention relates to a system and method for controlling the operating pressure of a liquid carbon dioxide receiving facility, comprising the steps of unloading liquid carbon dioxide from a transport vessel to the liquid carbon dioxide receiving facility, storing the liquid carbon dioxide in a temporary storage at the liquid carbon dioxide receiving facility, wherein the temporary storage comprises a carbon dioxide liquid phase and a carbon dioxide vapor phase, wherein the addition of the liquid carbon dioxide increases the level of the liquid phase within the temporary storage, pumping the liquid carbon dioxide from the temporary storage to permanent geologic storage or external use, wherein the removal of liquid carbon dioxide decreases the level of the liquid phase within the temporary storage, and managing pressure in the temporary storage using at least some of the carbon dioxide liquid phase. The temporary storage is selected from one or more horizontal vessels, vertical vessels, spheres, or a combination thereof. The liquid carbon dioxide is transported to the receiving facility using transport vessels selected from one or more of trucks, railcars, barges, ocean-going ships, pipelines, or a combination thereof.

In yet another embodiment of the present invention, at least a portion of the liquid carbon dioxide is subcooled, wherein the pressure of the temporary storage is reduced during the storing step by the addition of the subcooled liquid carbon dioxide to the temporary storage. This is achieved by spraying at least some of the subcooled liquid carbon dioxide as liquid droplets directly in the temporary storage to condense a portion of the carbon dioxide vapor phase and reduce the pressure of the temporary storage. This is also achieved by adding at least some of the subcooled liquid carbon dioxide below the liquid level of the carbon dioxide liquid phase and condensing carbon dioxide vapor phase on the surface of the vapor-liquid interface thereby indirectly reducing the pressure of the temporary storage. The subcooled liquid carbon dioxide is provided by unloading a transport vessel containing carbon dioxide as either a subcooled or saturated liquid that can be pumped to a pressure that exceeds the bubble point of transported fluid at the pressure of the temporary storage.

In another embodiment of the present invention, the managing pressure step further comprises vaporizing at least some of the carbon dioxide liquid phase at a rate sufficient to offset the pressure reduction caused by the pumping step. The carbon dioxide liquid phase is vaporized at a volumetric rate equal to the pumping rate of liquid carbon dioxide from the temporary storage minus the rate of boil-off gas generation rate due to heat ingress.

In yet another embodiment of the present invention, the managing pressure step further comprises vaporizing at least some of the carbon dioxide liquid phase at a rate sufficient to increase the pressure of the temporary storage. The carbon dioxide liquid phase is vaporized at a volumetric rate greater than the pumping rate of liquid carbon dioxide from the temporary storage minus the rate of boil-off gas generation rate due to heat ingress.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings therein. It is therefore evident that the particular embodiments disclosed above may be altered or modified and all such variations are considered within the scope and sprit of the present invention.

What is claimed is:

1. A method for controlling the operating pressure of a liquid carbon dioxide receiving facility, comprising:
unloading liquid carbon dioxide from a transport vessel to the liquid carbon dioxide receiving facility;
storing the liquid carbon dioxide in a temporary storage at the liquid carbon dioxide receiving facility, wherein the temporary storage comprises a carbon dioxide liquid phase and a carbon dioxide vapor phase, wherein the addition of the liquid carbon dioxide increases the level of the liquid phase within the temporary storage;
pumping the liquid carbon dioxide from the temporary storage to permanent geologic storage or external use, wherein the removal of liquid carbon dioxide decreases the level of the liquid phase within the temporary storage; and
managing pressure in the temporary storage using at least some of the carbon dioxide liquid phase.

2. The method of claim 1, wherein the pressure in the temporary storage increases due to boil-off gas generation due to heat ingress.

3. The method of claim 1, wherein the pressure in the temporary storage increases due to the increase in the level of the liquid phase within the temporary storage.

4. The method of claim 1, wherein the pressure in the temporary storage decreases due to the decrease in the level of the liquid phase within the temporary storage.

5. The method of claim 1, wherein at least a portion of the liquid carbon dioxide is subcooled, and wherein the pressure of the temporary storage is reduced during the storing step by the addition of the subcooled liquid carbon dioxide to the temporary storage.

6. The method of claim 1, wherein the managing pressure step further comprises vaporizing at least some of the carbon dioxide liquid phase at a rate sufficient to offset the pressure reduction caused by the pumping step.

7. The method of claim 6, wherein the carbon dioxide liquid phase is vaporized at a volumetric rate equal to the pumping rate of liquid carbon dioxide from the temporary storage minus the rate of boil-off gas generation rate due to heat ingress.

8. The method of claim 1, wherein the managing pressure step further comprises vaporizing at least some of the carbon dioxide liquid phase at a rate sufficient to increase the pressure of the temporary storage.

9. The method of claim 8, wherein the carbon dioxide liquid phase is vaporized at a volumetric rate greater than the pumping rate of liquid carbon dioxide from the temporary storage minus the rate of boil-off gas generation rate due to heat ingress.

10. The method of claim 5, further comprising spraying at least some of the subcooled liquid carbon dioxide as liquid droplets directly in the temporary storage to condense a portion of the carbon dioxide vapor phase and reduce the pressure of the temporary storage.

11. The method of claim 5, further comprising adding at least some of the subcooled liquid carbon dioxide below the liquid level of the carbon dioxide liquid phase and condensing carbon dioxide vapor phase on the surface of the vapor-liquid interface thereby indirectly reducing the pressure of the temporary storage.

12. The method of claim 5, wherein the subcooled liquid carbon dioxide is provided by unloading a transport vessel containing carbon dioxide as either a subcooled or saturated liquid that can be pumped to a pressure that exceeds the bubble point of transported fluid at the pressure of the temporary storage.

13. The method of claim 5, wherein the subcooled liquid carbon dioxide is provided by recirculating the subcooled liquid carbon dioxide back to temporary storage.

14. The method of claim 5, wherein pressure control for the temporary storage regulates the amount of subcooled liquid carbon dioxide added to the temporary storage.

15. The method of claims 6-9, wherein pressure control for the temporary storage increases or decreases the heat input to vaporize the liquid carbon dioxide.

16. The method of claim 1, wherein the temporary storage is selected from one or more horizontal vessels, vertical vessels, spheres, or a combination thereof.

17. The method of claim 1, wherein the liquid carbon dioxide is transported to the receiving facility using transport vessels selected from one or more of trucks, railcars, barges, ocean-going ships, pipelines, or a combination thereof.
